(19) United States
(12) Patent Application Publication
(10) Pub. No.: US 2025/0291024 A1
(43) Pub. Date: Sep. 18, 2025

(54) INTEGRATED RADAR DEVICE

(71) Applicant: Infineon Technologies AG, Neubiberg (DE)

(72) Inventors: Albrecht MAYER, Waakirchen (DE); Carsten KLAGGE, BOCHUM (DE); Christian MÜLLER, Künzell (DE); Thomas SANTA, Seeboden (AT)

(21) Appl. No.: 18/603,821

(22) Filed: Mar. 13, 2024

(51) Int. Cl. G01S 7/03

(52) U.S. Cl. CPC G01S 7/032

(57) ABSTRACT

A radar system that includes an integrated radar device is described. The integrated radar device includes both a Monolithic Microwave Integrated Circuit (MMIC) and a microcontroller housed in the same package. The microcontroller includes a high-speed serial (HSS) interface that is configured to receive raw radar data from the MMIC, within the package, and output the raw radar data to at least one processor of the microcontroller. An input/output (I/O) port of the package is coupled to the HSS interface. The I/O port may be used to record raw radar data from the MMIC from external to the package, and to input previously recorded raw radar data to the microcontroller from external to the package.

### TECHNICAL FIELD OF THE INVENTION

This invention relates generally to sensors, and more specifically to radar sensors configured to detect stationary or moving objects.

### BACKGROUND

Radar systems operate as sensors that utilize detections of backscattered microwave energy to detect information about stationary or moving objects. Radar systems are increasingly employed in modern vehicles and are used to provide automotive safety and convenience applications. For example, radar systems may be used, with or without other vehicle sensors to implement safety and/or convenience features in vehicles, non-limiting examples of which include blind spot monitoring, lane and lane-change assist, collision warning and avoidance, parking assist, and cross-traffic monitoring, brake assist, emergency braking, automatic distance control, and other applications up to and including advanced autonomous driving. In still other examples, radar systems may be installed in a vehicle interior and used to implement safety or convenience features such as child presence detection, or to sense gestures as a human-machine interface.

Traditional radar systems, which employ individually packaged discrete, components (e.g., radar transceiver and processing components) may be challenging to implement and may operate with undesirable performance or power usage. A need exists for improvements in radar systems that are relatively easy to implement and operate with desirable performance and/or reduced power usage in comparison to traditional radar systems.

### SUMMARY

This disclosure is directed to improvements in radar systems that are, for example, useable to implement one or more vehicle safety or convenience features. More specifically, this disclosure describes improvements to integrated radar devices that house multiple discrete semiconductor components within a single package to enable hardware-in-loop testing, development, and/or calibration of the integrated radar device.

As one example, a radar system is described. The radar system includes a package, a Monolithic Microwave Integrated Circuit (MMIC) housed within the package and configured to output raw radar data, and a microcontroller housed within the package. The microcontroller includes a high-speed serial (HSS) interface configured to receive the raw radar data from the MMIC within the package and output the raw radar data to one or more processors of the microcontroller. The radar system further includes an input/output (I/O) port of the package coupled to the HSS interface.

As another example, a method is described. The method includes arranging a Monolithic Microwave Integrated Circuit (MMIC) in a package. The method further includes arranging a microcontroller in the package. The method further includes coupling raw radar data from the MMIC to the microcontroller via a high-speed serial (HSS) interface that receives the raw radar data from the MMIC within the package and outputs the received raw radar data to at least one processor of the microcontroller. The method further includes coupling an I/O port of the package to the HSS interface.

As another example, a method is described. The method includes coupling a tool to an I/O port of a radar system that includes a package that houses a Monolithic Microwave Integrated Circuit (MMIC) and a microcontroller within the package. The I/O port is coupled to a high-speed serial (HSS) interface of the microcontroller configured to receive raw radar data from the MMIC within the package and output the received raw radar data to at least one processor of the microcontroller. The method further includes using the tool coupled to the I/O port to access the HSS interface from external to the package.

### BRIEF DESCRIPTION OF THE DRAWINGS

The present invention will now be described, by way of example with reference to the accompanying drawings, in which:

FIG. 1 is a block diagram that depicts a radar system that includes an integrated radar device according to some embodiments.

FIG. 2 is a block diagram that depicts an integrated radar device according to some embodiments.

FIG. 3 is a block diagram that depicts an integrated radar device according to some embodiments.

FIG. 4 is a block diagram that depicts one example of an integrated radar device with an input/output (I/O) port configured to be coupled to one or more tools according to some embodiments.

FIG. 5 is a block diagram that depicts one example of an integrated radar device that includes one or more switches according to some embodiments.

FIG. 6 is a block diagram showing the integrated radar device depicted in FIG. 5 operated in a standard mode according to some embodiments.

FIG. 7 is a block diagram showing the integrated radar device depicted in FIG. 5 operated in a replay mode according to some embodiments.

FIG. 8 is a block diagram showing the integrated radar device depicted in FIG. 5 operated in a recording mode according to some embodiments.

FIG. 9 is a flow diagram depicting a method of making an integrated radar device according to some embodiments.

FIG. 10 is a flow diagram depicting a method of operating an integrated radar device according to some embodiments.

### DETAILED DESCRIPTION

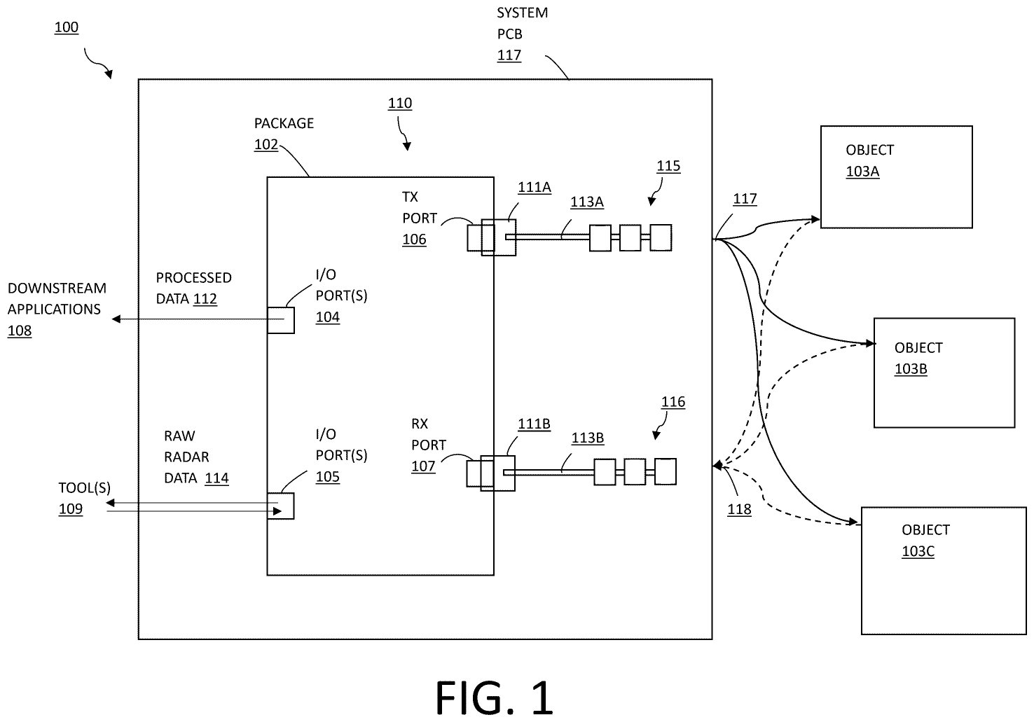

FIG. 1 is a block diagram that illustrates one example of a radar system 100 that includes an integrated radar device 110 according to some embodiments. The example of FIG. 1 is provided to explain the operation of respective components of radar system 100 and is not necessarily drawn to scale.

Radar system 100 is operable to sense characteristics of stationary or moving objects 103A-103C in a field of view of the radar system 100, such as a range, velocity, acceleration, heading, or other characteristic of the objects 103A-103C. Radar system 100 may, for example, be mounted on a vehicle and used to detect objects 103A-103C in the environment of the vehicle such as a stationary or moving vehicle, a pedestrian, a bicycle, roadway infrastructure, or other object on or near a roadway on which the vehicle is travelling. Radar system 100 may be used, in some examples along with other radar or other sensor input, to track the objects 103A-103C and implement safety and/or convenience features of the vehicle in response to the tracked objects 103A-103C. Although not depicted in FIG. 1, radar system 100 may be housed in cover as a radar module and mounted at one or more locations on a vehicle, for example the front, corners, sides, or roof of the vehicle.

Radar system 100 includes an integrated radar device 110, TX antenna 115 and RX antenna 116 arranged on a system printed circuit board (PCB) 119. The TX antenna 115 and the RX antenna 116 include one or a plurality of patch arrays, slots, microstrips, or other conductive structures formed on or in a surface of the system PCB 119, for example a patch array antenna, a slotted waveguide antenna, or other antenna structure(s) configured to emit and/or detect microwave energy. The integrated radar device 110 includes at least one TX port 106 that is coupled to a transmit (TX) antenna 115 on or in the system PCB 119 by a waveguide 111A and a trace 113A on or in the system PCB 119, and at least one RX port 107 that is coupled to a receive (RX) antenna 116 on or in the system PCB 119 by a waveguide 111B and a trace 113B on or in the system PCB 119.

The integrated radar device 110 may be referred to as radar “System in Package” (SIP) that includes a single package 102 that houses and enables electrical connections with both radar transceiver and processor components that would be implemented by discrete components in separate packages in traditional non-integrated radar systems.

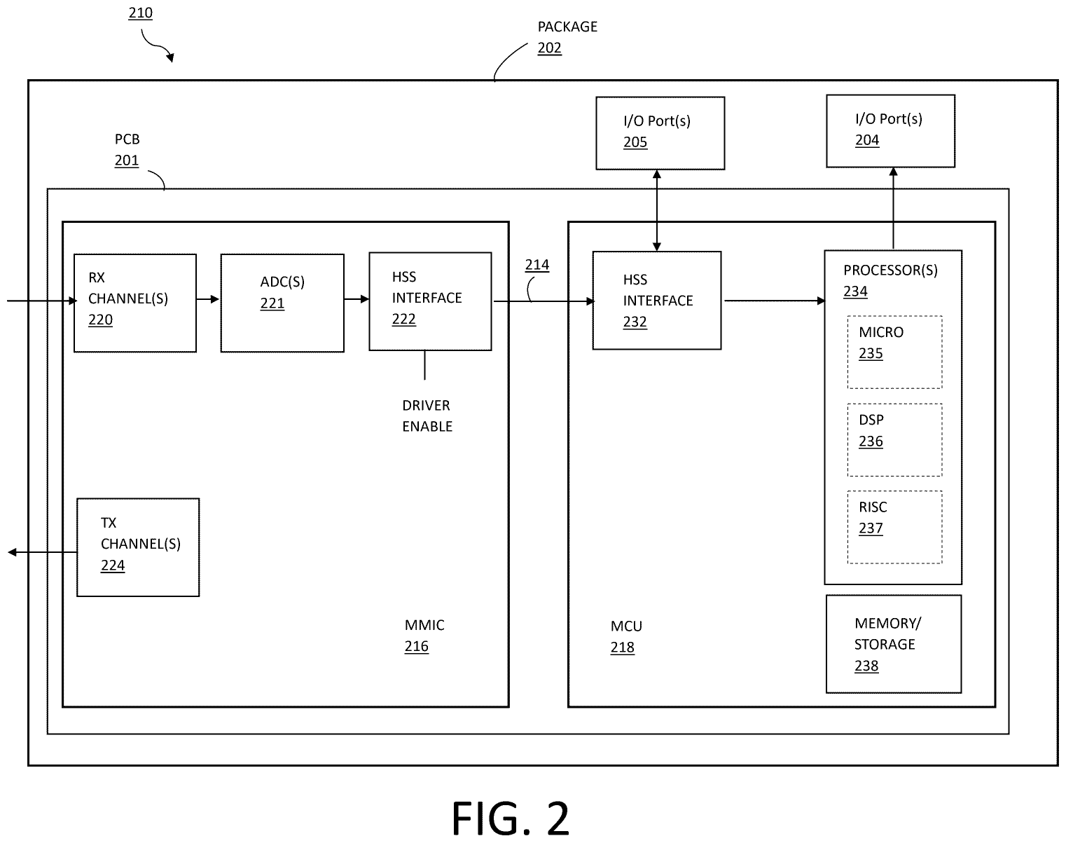

The integrated radar device 110 is configured to operate as a radar transceiver (e.g, a MMIC 216 as depicted in FIG. 2) to generate raw radar data 114 within the package 102 by exciting the TX antenna 115 to radiate microwave frequency energy 117 toward one or more objects 103A-103C, and synchronously detect reflected energy 118 backscattered from the one or more objects 103A-103B via the RX antenna 116. The raw radar data 114 is digital data that includes detection-level data that reflects characteristics of detections of the reflected energy 118 sensed via the RX antennae 116.

In addition to operating as a radar transceiver, integrated radar device 110 also operates as a processor (e.g., a microcontroller 218 depicted in FIG. 2) to process the raw radar data 114 to generate processed radar data 112. The processed radar data 112 reflects object-level characteristics of one or more objects 103A-103C that the reflected energy 118 was backscattered from. In the example of FIG. 1, the integrated radar device 110 includes one or more optional input/output (I/O) port(s) 104 that are configured to enable access to the processed radar data 112 by one or more downstream applications 108, for example object tracking or other vehicle systems.

As shown in FIG. 1, the integrated radar device 110 further includes one or more input/output (I/O) port(s) 105 that enable access to raw radar data 114 generated within the package 102 from external to the package 102. As described in further detail below, the I/O port(s) 105 are coupled to a communication interface, such as a high-speed serial (HSS) interface (not shown in FIG. 1) within the package 102 that is used to communicate raw radar data 114 between distinct components (e.g., MMIC 216 and microcontroller 218 depicted in FIG. 2) housed within the package 102. In this manner, the I/O port(s) 105 are coupled to the same HSS interface that is configured to receive raw radar data 114 communicated within the package 102.

While only a single I/O port 105 is depicted in FIG. 1, the integrated radar device 110 may in some examples be a pair of I/O port(s) 105 that carry a differential raw radar data 114 signal. The I/O port(s) 105 may enable multiple phases of “hardware-in-loop” testing of integrated radar device 110 and/or radar system 100. For example, in a recording phase, one or more tool(s) 109 (a recording tool) are connected to the I/O port(s) 105 to record raw radar data 114 generated in the package 102. In a replay phase, the same, or other tool(s) 109 (e.g., a replay tool), are coupled to the same I/O port(s) 105 to input previously recorded raw radar data to the package 102.

Radar system 100, which employs an integrated radar device 110 to operate as both as a radar transceiver that generates raw radar data 114 and a processor (e.g., a microcontroller) that processes the raw radar data 114 to generate processed radar data 112, may offer significant advantages in comparison to traditional radar systems. For example, integrated radar device 110 may be relatively easy to implement in radar system 100. In addition, integrated radar device 110 may also operate with enhanced performance and/or reduced energy usage in comparison with traditional radar sensor systems that employ discrete, separately packaged components, such as separate radar transceiver and processor components. Integrated radar device 110 may further offer the benefits of integration at reduced cost and complexity in comparison with other known integrated radar that include distinct pairs of I/O ports on the package to support each of the respective recording and replay phases of hardware-in-loop testing, and employ a dedicated CSI-2 communication interface implemented in silicon that is used only to support inputting previously recorded raw radar data to be processed in the replay phase.

One example of an integrated radar device 110 that may be used in the radar system 100 depicted in FIG. 1 is depicted in FIG. 2, which shows an integrated radar device 210 that includes a package 102, a Monolithic Microwave Integrated Circuit (MMIC) 216 housed within the package 102 and configured to output raw radar data 214, and a microcontroller 218 housed in same package 102. The example of FIG. 2 is provided to explain the operation of respective components of integrated radar device 210 and is not necessarily drawn to scale.

The MMIC 216 is an integrated circuit implemented in a first silicon substrate (the MMIC substrate), and the microcontroller 218 is an integrated circuit implemented in a second, different silicon substrate (the microcontroller 218 substrate) in the package 202. Neither of the MMIC 216 or the microcontroller 218 substrates are housed in a dedicated package, instead both are “bare” silicon substrates (e.g., individual singulations of one or more semiconductor wafers) housed in the single package 202. In the example of FIG. 2, the MMIC 216 substrate and the microcontroller 218 substrate are arranged adjacent to one another on a printed circuit board (PCB) 201 that is also housed in the single package 202.

Although not shown in FIG. 2, one or more other discrete electrical components implemented in one or more other separate and distinct “bare” silicon substrates may also be housed within the package 202, along with the MMIC 216 substrate and the microcontroller 218 substrate. As one specific example, a power management integrated circuit (not shown in FIG. 2) that manages power supplied to the MMIC 216 and the microcontroller 218 may also be housed in the package 102.

The MMIC 216 includes both passive and active components that are monolithically integrated in the MMIC 216 substrate that operate as a radar transceiver to generate raw radar data 214 based on detections of reflected energy 118 backscattered from one or more object(s) 103A-103C, as depicted in the example of FIG. 1. The microcontroller 218 includes one or more processor(s) 234 (e.g., processor cores) and/or at least one memory/storage 238 component monolithically embedded in the microcontroller 218 substrate. The processor(s) 234 are operable to execute instructions stored in the memory/storage 238 or elsewhere to process raw radar data 214 to generate processed radar data. The package 202 is a semiconductor package that includes an insulative housing configured to protect the MMIC 216, microcontroller 218, PCB 201, and/or other components housed within the package 202.

As shown in FIG. 2, the MMIC 216 includes one or more transmit (TX) channel(s) 224 and one or more receive (RX) channel(s) 220 that operate synchronously with one another based on a stable clock from an oscillator (not shown) to radiate energy 117 and detect reflected energy 118 backscattered from one or more objects 103A-103C, as depicted in the example of FIG. 1. Only a single TX channel 224 and a single RX channel 220 are shown in FIG. 2 for case of illustration. In other examples, the MMIC 216 may include more TX and/or more RX channel(s) that operate synchronously to emit energy 117 and detect reflected energy 118 in parallel in real-time.

Although not depicted in FIG. 2, the TX channel(s) 224 and the RX channel(s) 220 may be coupled to one or more antenna structures to emit and detect energy. For example, referring now system 100 depicted in FIG. 1, the TX channel(s) 224 may be coupled through one or more TX port(s) 106, a waveguide 111A, and a trace 113A (e.g., a microstrip transmission line) to TX antenna 115 to excite the TX antenna 115 to emit energy 117, as shown in FIG. 1. Similarly, the RX channel(s) 220 may be coupled through one or more RX port(s) 107 via a waveguide 111B, and a trace 113B (e.g., a microstrip transmission line) to RX antenna 116 to detect reflected energy 118, as shown in FIG. 1. In some examples, the system 100 includes multiple RX antenna 116, and the RX channel(s) 220 are each coupled to a separate RX antenna 116 structures, for example via additional RX port(s) 106. In other examples, multiple RX channel(s) 220 are coupled to a single RX antenna 116 structure to detect reflected energy 118. The TX channel(s) 224 may include one or multiple channels, which may similarly be coupled to one, or multiple, TX antenna 115 via one or more TX port(s) 107.

The TX channel(s) 224 operate to excite the TX antenna 115 to radiate energy 117 in a distinguishable pattern. For example, the MMIC 216 may operate as a Frequency Modulated Continuous Wave (FMCW) radar transceiver in which TX channel(s) 224 excite the TX antenna 115 to emit energy 117 in a continuous wave that is modulated by a frequency that changes over time.

The RX channel(s) 220 are coupled to the RX antenna 116 and are configured to receive detections of reflected energy 118 from the RX antenna 116 and generate one or more analog output waveform(s) that represent the detections. For example, the RX channel(s) 220 may include components (not shown) that amplify and/or otherwise condition a signal from the RX antennal 16 to prepare analog output waveform(s) for sampling.

The MMIC 216 further includes one or more analog to digital converters (ADC(S)) 221 that sample the analog waveform(s) from the RX channel(s) 220 and generate a digitized version of the analog waveform(s), which may be referred to as “raw ADC data” or “raw radar data” 214 herein. The raw radar data 214 may be described as including detection-level data that that indicates characteristics of detections sensed by the MMIC 216 via the RX antenna 116, in contrast with processed radar data 212, which includes object-level data that indicates characteristics of one or more object(s) 103A-130C generated based on processing the raw radar data 214. As non-limiting examples, the processed radar data 212 may include a range to the one or more objects 103A-103C, a speed of the one or more objects 103A-103C, and/or a heading of the one or more objects 103A-103C.

The MMIC 216 includes a high-speed serial (HSS) interface 222 configured to communicate raw radar data 214 to the microcontroller 218 within the package 102. The HSS interface 222 is configured as an output of the MMIC 216 and includes circuitry monolithically integrated in the MMIC 216 substrate with the TX channel(s) 224, the RX channel(s) 220, and the ADC(s) 221 that is configured to serialize digital bit stream(s) from the RX channel(s) 220 and the ADC(s) 221 and output the raw radar data 214 to the microcontroller 218. Although not shown in FIG. 2, the HSS interface 222 may include a driver configured to be selectively enabled or disabled to output raw radar data 214 via a driver enable input.

HSS interface 232 of the microcontroller 218 includes circuitry monolithically integrated with the processor(s) 234 in the microcontroller 218 substrate and is configured as an input of the microcontroller 218 to receive raw radar data 214 and output the raw radar data 214 to processor(s) 234. The processor(s) 234 include one or more processing cores that are configured to execute instructions stored in memory/storage 238 to process the raw radar data 214 from the MMIC 216 to generate processed radar data 112. In some examples, the microcontroller 218 includes processor(s) 234 of different types. For example, as shown in FIG. 2, microcontroller 218 may include one or more of a microprocessor 235, a digital signal processor (DSP) 236, a redundant instruction computing (RISC) processor 237, a graphics processing unit (GPU) (not shown), or any other processor core or other circuitry not depicted that be used to process raw radar data 214 to generate processed radar data. In other examples not depicted, microcontroller 218 may include only a single processor core, or multiple processor 234 cores of the same type, for example multiple microprocessor cores 235 and/or multiple DSP 236 cores.

As shown in FIG. 2, in some examples, the microcontroller 218 is coupled to one or more optional I/O port(s) 204 that enable access to processed radar data output from the processor(s) 234 from external to the package 202. The I/O port(s) 204 may be coupled to by other components or systems of a vehicle assembly to access processed radar data to implement one or more safety, convenience, or other features of the vehicle.

The HSS interfaces 222, 232 may be any interfaces configured to communicate raw radar data 214 at high bandwidths. One example of such an interface is a mobile industry processor interface (MIPI) Camera Serial Interface 2 (CSI-2), which may offer a maximum bandwidth of 10 Gigabyte per second with four image data lanes that are each capable of transferring data at bandwidths up to 2.5 GB per second. Another example of such an interface is the MIPI Camera Serial Interface 3 (CSI-3), which may support even higher bandwidths for image data and be suitable to communicate raw radar data as described herein. Another such example of such an interface is a proprietary High Speed Serial Link (HSSL) interface. The HSS interface 232 of the microcontroller 218 may receive raw radar data 214 from the MMIC 216 (i.e., from the HSS interface 222) in serialized form, deserialize the raw radar data 214, and output the deserialized raw radar data 214 to the processor(s) 234.

The processor(s) 234, for example DSP 236, may perform various steps to process the raw radar data 214 from the HSS interface 232 to generate processed radar data based on the raw radar data 214. The processor(s) 234 may execute instructions, for example stored in memory/storage 238, to perform signal analysis on the raw radar data 214 to generate processed radar data. For example, processor(s) 234 may perform a range Fast Fourier Transform (FFT) to extract range information based on the raw radar data 214. As another example, the processor(s) 234 may perform a Doppler FFT on the raw radar data 214 to extract velocity information based on the raw radar data 214. As still another example, the processor(s) 234 may perform energy collation and/or object detection based on the raw radar data 214. As another example, the processor(s) 234 may perform angle estimation to extract azimuth and/or elevation based on the raw radar data 214. In some examples, the processor(s) 234 may further perform more advanced radar signal processing such as object classification and/or tracking based on the raw radar data 214. The processor(s) 234 may perform signal analysis as described to generate processed radar data, which in contrast with raw radar data 214, may include object level data generated based on processing the raw radar data 214 that the processor(s) 234 received as an input via the HSS interface 232.

As shown in FIG. 2, integrated radar device 210 also includes I/O port(s) 205 that are coupled to the HSS interface 232 of the microcontroller 218 to enable access to the HSS interface 232. The I/O port(s) 205 are configured to be used to implement multiple phases of “hardware-in-loop” testing, for example to implement both recording and playback phases used to develop, test, and/or calibrate integrated radar device 210 and/or radar system 100. For example, the same I/O port(s) 205 may enable access to raw radar data 214 from the MMIC 216 from external to the package 202, and also enable previously recorded raw radar data to be input to the microcontroller 218 for processing.

Integrated radar device 210 may uniquely support Hardware-in-loop testing at a low relative cost in terms of I/O footprint and/or the silicon “real estate” that are used to implement the respective recording and replay phases. For example, by using a single I/O port or pair of I/O port(s) 205 to implement both recording and replay of raw radar data, I/O port(s) that would have been used to support each separately can be used for other purposes. Furthermore, as noted above, by coupling the I/O port(s) 205 to an HSS interface 232 that is already used to receive raw radar data 214 from MMIC 216 within package 202, additional circuitry (e.g., a dedicated HSS Interface used only to input previously recorded raw radar data) implemented in silicon specifically to support the replay phase may be avoided.

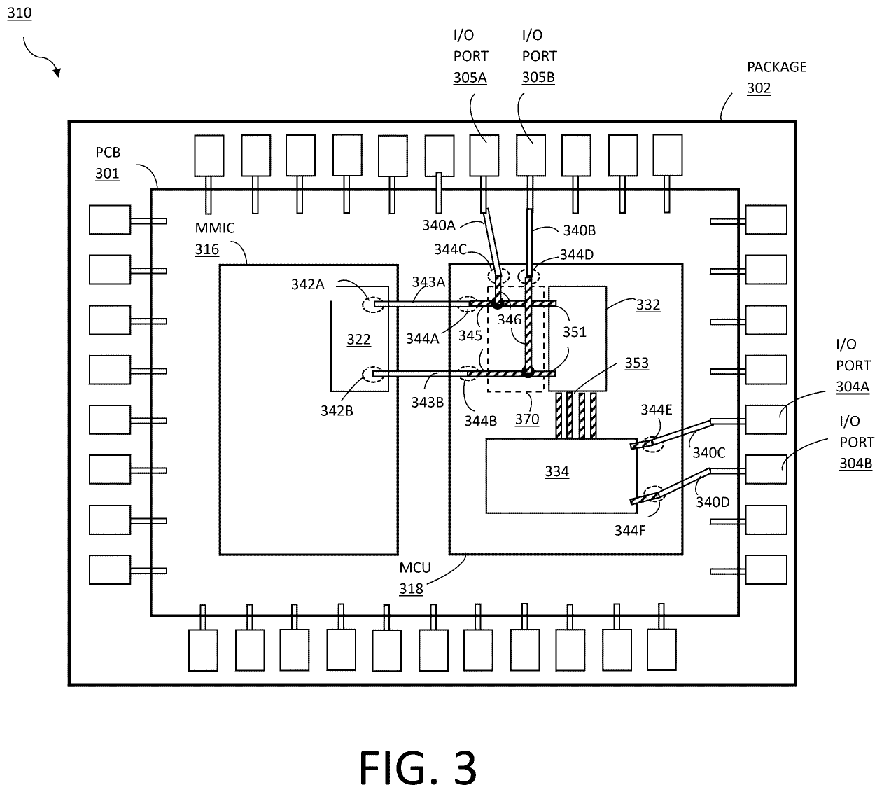

FIG. 3 is block diagram depicting an integrated radar device 310 that includes a package 302 and both a radar MMIC 316 and a microcontroller 318 housed within a package 302. The example of FIG. 3 is presented to explain the interrelationship of components of the integrated radar device 310 and is not necessarily drawn to scale. The radar MMIC 316 and a microcontroller 318 are arranged on a PCB 301 arranged adjacent to one another in the package 302 and operate similarly to MMIC 216 and microcontroller 218 depicted in FIG. 2.

Like the example of FIG. 2, the MMIC 316 includes an HSS interface 322 configured as an output of the MMIC 316 to output raw radar data. According to the example of FIG. 3, The HSS interface 322 is configured to output raw radar data as a differential signal at a pair of I/O ports 342A, 342B (represented by the dashed line oval in FIG. 3) of the MMIC 316 substrate to a first end of a pair of traces 343A, 343B on or in the PCB 301, for example by a pair of solder balls (not shown) that couple the MMIC 316 I/O ports 342A-342B to the traces 343A, 343B. The pair of traces 343A, 343B are a pair of conductors on or in a surface of the PCB 301 and configured to carry data at high speeds to microcontroller 318 according to a communications protocol associated with the HSS interface 322 (and the HSS interface 332, which corresponds to the HSS interface 322).

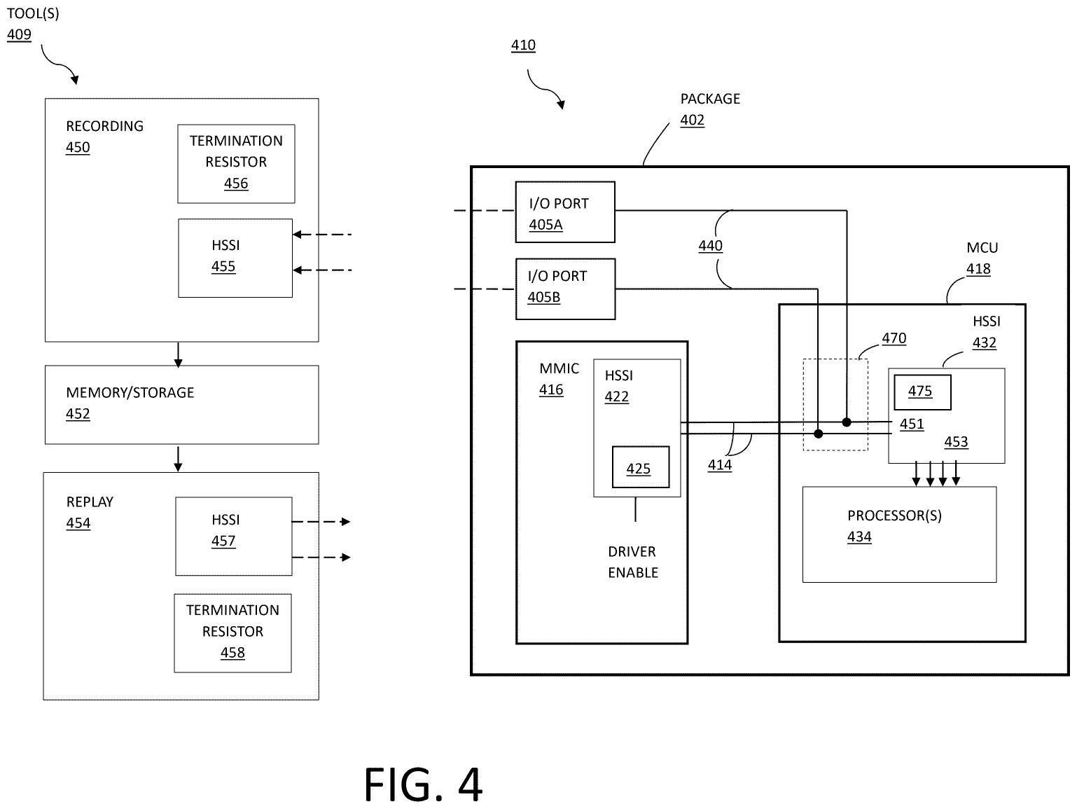

Like in the example of FIG. 2, the microcontroller 318 includes an HSS interface 332 that is configured to receive raw radar data from the MMIC 316 within the package 302 and output the raw radar data from the MMIC 316 to one or more processor(s) 334 of the microcontroller 318. According to the example of FIG. 3, microcontroller 318 includes a pair of I/O ports 344A, 344B that are coupled to a second end of the pair of traces 343A, 343B, for example by a pair of solder balls (not shown) that couple the microcontroller 318 I/O ports 342A-342B to the traces 343A, 343B. Intra-chip conductors 345, represented by diagonal hashing in the FIG. 3 example, couple the microcontroller 318 I/O ports 344A, 344B to a pair of inputs 351 of the HSS interface 332. As shown in FIG. 4, the HSS interface 332 further includes an output 353 coupled to the processor(s) 334 by other intra-chip conductors to output raw radar data to the processor(s) 334.

Processor(s) 334 are configured to process raw radar data to generate processed radar data and optionally include outputs coupled to a pair of I/O ports 344E, 344F of the microcontroller 318 which are configured to enable access to processed radar data and/or other data or signals generated by the processor(s) 334. As shown in FIG. 3, the pair of microcontroller I/O ports 344E, 344F are coupled to a first end of a pair of traces 340C, 340D on the PCB 301. A second end of the pair of traces 340C, 340D are coupled to I/O ports 304A and 304B, which are a pair among many I/O ports arranged around a periphery of the integrated radar device 310 package 302 in the FIG. 3 example.

Integrated radar device 310 further includes a pair of I/O ports 305A, 305B of the package 302 that are coupled to the HSS interface 332, specifically to the pair of inputs 351 of the HSS interface 332 in the FIG. 3 example. As shown in FIG. 3, intra-chip conductors 345 that carry raw radar data from the microcontroller I/O ports 344A, 344B to the inputs 351 are tapped by other intra-chip conductors 346 that are coupled to another pair of microcontroller I/O ports 344C, 344D. The microcontroller 318 I/O ports 344C, 344D are coupled, for example via solder balls (not shown), to a first end of a pair of traces 340A, 340B in or on the PCB 301. A second end of the pair of traces 340A, 340B is coupled to the pair of I/O ports 305A, 305B of the package 302. Through the intra-chip conductors 346 and the traces 340A and 340B, the I/O ports 305A, 305B are coupled to the inputs 351 of the HSS interface 332. Through the depicted taps to the intra-chip conductors 345, the I/O ports 305A, 305B are coupled to the pair of microcontroller 318 I/O ports 344A, 344B, which are the same microcontroller I/O ports (and the same pair of solder balls) used to couple the HSS interface 332 to the MMIC 316 to receive raw radar data from the MMIC 316.

In the example depicted in FIG. 3, the I/O ports 305A, 305B are coupled to a pair of inputs 351 of the HSS interface 332 within the microcontroller 318 substrate, via intra-chip conductors 346 and microcontroller I/O ports 344C and 344D. In other examples not depicted, the I/O ports 305A, 305B are coupled to the inputs 351 external to the microcontroller 318 substrate, for example by traces (not shown) coupled directly to traces 343A, 343B, and/or to a pair of solder balls that couple the microcontroller I/O ports 344C and 344D to the traces 343A, 343B.

The I/O ports 305A, 305B may be described as being directly coupled to the pair of inputs 351 of the HSS interface 332. For example, as shown in the FIG. 3 example, I/O ports 305A, 305B are coupled to the inputs 351 only through intra-chip conductors 346 and traces 340A and 340B without any additional circuitry or components, other than conductive structures that carry the raw radar data, in between that may modify the raw radar data. The I/O ports 305A, 305B are therefore directly coupled to the inputs 351 in the sense that a raw radar data signal at the I/O ports 305A, 305B is substantially identical to a raw radar data signal at the pair of microcontroller I/O ports 344A and 344B that couple the microcontroller 318 to the MMIC 316. In contrast, the I/O port(s) 304A, 304B are not coupled to the HSS interface 323 and are instead coupled to receive processed radar data after it has been processed by the processor(s) 334.

FIG. 3 illustrates just one example of a possible arrangement of the I/O ports 304A, 304B, 305A, 305B, which may be contact pads arranged around a periphery of package 302 that support solder balls to couple to the integrated radar device 310 from external to the package 302, for example to traces on a system PCB 119 as shown in FIG. 1. In other examples, the package 302 may include two or more rows of such contact pads arranged around the periphery of package 302. In still other examples, the package 302 includes other types of I/O ports 304A, 304B, 305A, 305B, for example wire bond landing sites, through-hole pins, or other similar structures for establishing electrical connection from external to package 302. In still other examples not depicted in FIG. 3, at least some of I/O ports 304A, 304B, 305A, 305B may not be positioned around a perimeter of the package 302 and instead are positioned at other locations, for example on an underside of the package 302 underneath the MMIC 316 and/or microcontroller 318 substrates.

In some examples, the HSS interfaces 322, 332 may rely on close transmission line matching to operate as intended to transmit and receive raw radar data at high speeds. Although not specifically depicted in the example of FIG. 3, which is not drawn to scale, in some examples, traces 340A, 340B may have a significant length of up to a few centimeters. In some examples, traces 340A, 340B may act as an antenna and cause a transmission line mismatch that could impact operation of the HSS interfaces 322, 332 to communicate raw radar data.

As indicated by the dashed line in FIG. 3, in some examples, integrated radar device 310 may further include one or more switches 370 that are coupled between the inputs 351 and the I/O ports 305A, 305B that are controllable, for example via the processor(s) 334 of the microcontroller 318 in response to user input, depending on an operating mode of the integrated radar device 310. In some examples, the switches 370 may be arranged proximal to the HSS interface 332 inputs 351 and distal from the I/O ports 305A, 305B, to mitigate impact on transmission line matching as much as possible.

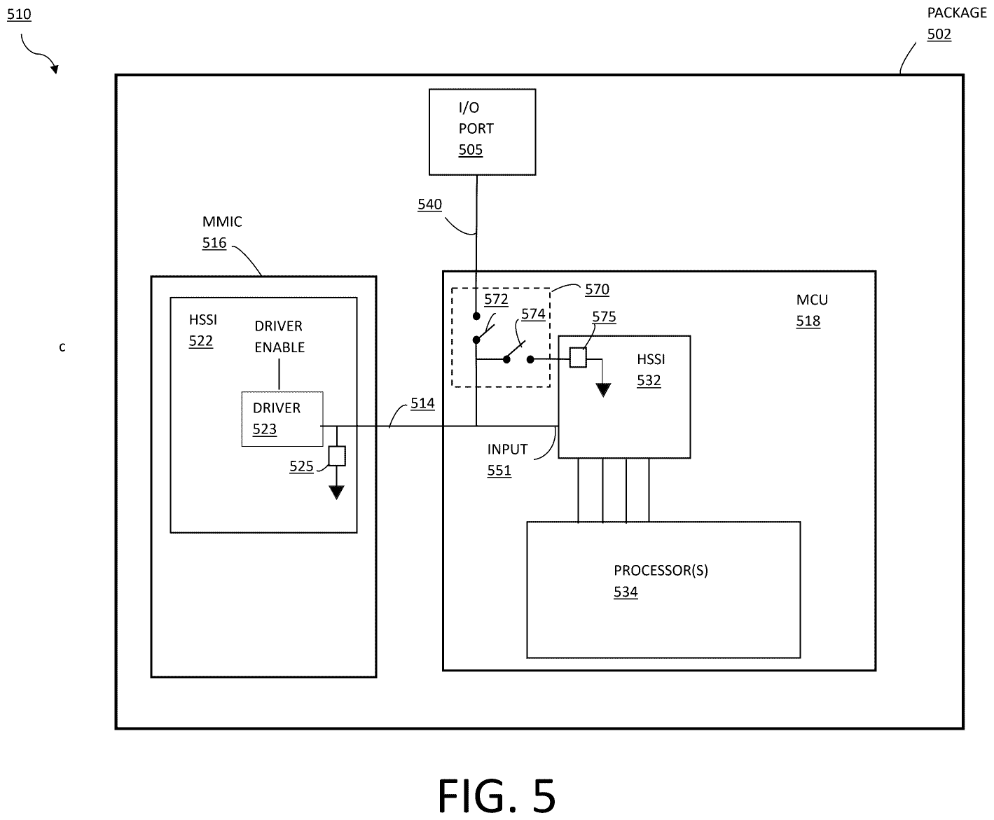

As one example, the switches 370 are transmission switches 572 that are coupled between the HSS interface 332 inputs 351 and the I/O ports 305A, 305B, for example arranged to interrupt the intra-chip conductors 346 coupled between the inputs 351 and the microcontroller I/O ports 344C, 344D, as further described below with respect to the example of FIG. 5. In other examples, the switches 370 instead, or in addition, include termination switches 574 coupled between the inputs 351 and the I/O ports 305A, 305B, for example between the intra-chip conductors 345, 346 and a termination resistor (not shown in FIG. 3), as also shown in FIG. 5.

In some examples, one or more of the HSS interface 332 and/or the optionally included switches 370 may be strategically arranged on the microcontroller 318 substrate to simplify coupling to the I/O ports 305A, 305B and/or to reduce a length of traces 340A, 340B. Accordingly, in some examples, the HSS interface 332 and/or switches 370 may be arranged on a side of the microcontroller 318 substrate adjacent to the MMIC 316, in a corner of the microcontroller 318 substrate close to the I/O ports 305A, 305B. As an example, microcontroller 318 depicted in FIG. 3 includes both HSS interface 332 and switches 370 arranged in an upper left corner of the microcontroller 318 substrate close to HSS interface 322 of MMIC 316 and I/O ports 305A, 305B. In another example not depicted, the HSS interface 332 and/or the switches 370 may be arranged in a lower left corner of the microcontroller 318 substrate close to other I/O ports of the package 302.

FIG. 4 is block diagram depicting an integrated radar device 410 that includes a package 402, and a radar MMIC 416 and a microcontroller 418 that are both housed in the single package 402. The example of FIG. 4 is presented to explain the interrelationship of components of the integrated radar device 410 and is not necessarily drawn to scale. The MMIC 416 and the microcontroller 418 operate similarly as the respective MMIC 216 and microcontroller 218 depicted in FIG. 2, and may be coupled within the package 402 as shown in FIG. 3 in some embodiments. Like the example of FIG. 2, the MMIC 416 is configured to output raw radar data 414 to the microcontroller 418. Also like the example of FIG. 2, the microcontroller 418 includes an HSS interface 432 which is coupled, at an input 451 to receive raw radar data 414 from the MMIC 416 within the package 402, and output the raw radar data 414 from the MMIC 416 to one or more processor(s) 434 of the microcontroller 418.

In some examples, as shown in FIG. 4, the HSS interface 422 of the MMIC and the HSS interface 432 are matched to one another to prevent transmission line reflections from impacting communications. For example, as shown in FIG. 4, HSS interface 422 include a termination resistor 425, and HSS interface 432 includes an termination resistor 475. The respective termination resistors 425, 475 may be coupled between terminals of the respective HSS interfaces 422, 432 and ground, which may have the same or different resistance values selected to match the HSS interfaces 422, 432 to one another.

Integrated radar device 410 includes a pair of I/O ports 405A, 405B that are coupled to the HSS interface 432, specifically to a pair of inputs 451 of the HSS interface The pair of I/O ports 405A, 405B are configured to support “Hardware-In-Loop” testing of the integrated radar device 410. I/O port(s) 405A, 405B are coupled, through a conductor 440 (e.g., via intra-chip conductors 346, traces 340A, 340B depicted in FIG. 3), to the pair of inputs 451 to access the HSS interface 432.

As shown by the dashed lines and arrows in FIG. 4, or more tool(s) 409 may be coupled to the I/O ports 405A, 405B to implement “Hardware-in-loop” testing. For example, in a recording mode, a recording tool 450 is coupled to the I/O ports 405A, 405B, and the HSS interface 422 output driver 423 is enabled to output raw radar data 414 to the microcontroller 418. The recording tool 450 includes or is coupled to memory/storage 452, which the recording tool 450 is configured to access to record raw radar data 414 as integrated radar device 410 is used to detect objects and generate raw radar data 414, for example by storing raw radar data 414 generated the MMIC 416 to memory/storage 452.

Coupled as shown in FIG. 4, the I/O ports 405A, 405B enable the recording tool 450 to access and record substantially the same raw radar data 414 (e.g., the same raw radar data signal) that is received at the inputs 451 of the HSS interface 432, which is output to processor(s) 434 at outputs 453 to be processed to generate processed radar data. In some examples, the recording tool 450 itself includes an HSS interface 455, which is used to receive the raw radar data 414 from the MMIC 416 as input and deserialize it for storage. In some examples, the recording tool 450 further includes a termination resistor 456 coupled to the HSS interface 455 that operates to match the HSS interface 455 to HSS interface 422 of the MMIC 416 to enable recording tool 450 to effectively operate to receive raw radar data 414 from the MMIC 416 for recording at high speeds.

As another example shown in FIG. 4, in a replay mode, a replay tool 454 may be coupled to the same I/O ports 405A, 405B. The replay tool 454 is configured to read previously recorded raw radar data from memory/storage 452, and output the previously recorded raw radar data to the microcontroller 418 within the package 402 using the I/O ports 405A, 405B. In some examples, the replay tool 454 includes an HSS interface 457 that operates to serialize and output the previously recorded raw radar data to be input to the HSS interface 432 via the inputs 451. In some examples, the replay tool 454 further includes a termination resistor 458 coupled to the HSS interface 457 that operates to match the HSS interface 457 to HSS interface 432 of the microcontroller 418 to enable the replay tool 450 to effectively operate to communicate raw radar data 414 from the memory/storage 452 to the microcontroller 418 at high speeds for processing.

As described above with respect to FIG. 3, conductors 440 (e.g., including traces 340A, 340B) that couple the I/O ports 405A, 405B to the HSS interface 432 may impact transmission line matching between one or more of the HSS interfaces 422, 432, 455 and/or 457 in some examples. In some embodiments, as indicated by the dashed line box depicted in FIG. 4, integrated radar device 410 further includes one or more switches 470 coupled between the inputs 451 and the I/O ports 405A, 405B that are configured to be controlled to mitigate a transmission line mismatch that may be caused by the conductors 440. As shown in FIG. 4, the switches 470 may be coupled proximal to the inputs 451 and distal from the I/O ports 405A, 405B.

The switches 470 may be controllable in an opened or closed state, based on user input and/or instructions executing on processor(s) 434, depending on an operating mode of integrated radar device 410. For example, a control gate each of switches 470 may be coupled to an output of processor(s) 434, which control a state of the switches 470. As one example, the microcontroller 418 may include one or more register(s) (e.g., in memory/storage 238 depicted in FIG. 2) configured to store a value that reflects operating mode of integrated radar device 410. The processor(s) 434 may access the register(s) and control the switches 470 based on the stored value. In some examples, such a value may be accessible to enable Hardware-in-Loop testing in recording and replay modes during development, testing, and/or calibration of integrated radar device 410, and may be rendered inaccessible when integrated radar device 410 is implemented as part of a radar system 100 as shown in FIG. 1 in a radar module for use in production vehicles.

In some examples, the switches 470 are transmission switches 572 as shown in FIG. 5 that are configured to decouple the I/O ports 405A, 405B from the HSS Interface 432 in a standard mode. In other examples, the switches 470, instead, or in addition, are termination switches 574 as also shown in FIG. 5. According to these examples, the termination switches 574 are configured to couple a termination resistor 575 of the microcontroller 418 to the HSS interface 432 in the standard and replay modes, and to decouple the termination resistor 575 from the HSS interface 432 in the recording mode.

FIG. 5 is block diagram depicting an integrated radar device 510 that includes a package 502, and a radar MMIC 516 and a microcontroller 518 that are both housed in the single package 502. The example of FIG. 5 is presented to explain the interrelationship of components of the integrated radar device 510 and is not necessarily drawn to scale. The MMIC 516 and the microcontroller 518 operate similarly to the respective MMIC 216 and microcontroller 218 depicted in FIG. 2 and may be coupled to one another within package 502 as shown in the example of FIG. 3 in some embodiments. Like the example of FIG. 2, the microcontroller 518 includes an HSS interface 532 which is coupled, at an input 551, to receive raw radar data 514 from the MMIC 516 within the package 502, and output the raw radar data 514 from the MMIC 516 to one or more processor(s) 534 of the microcontroller 518. The integrated radar device 510 further includes an I/O port 505 coupled the HSS interface 532. More specifically, the I/O port 505 is coupled to the input 551 of the HSS interface 532 by a conductor 540, which may include a trace 340A, 340B on a PCB 301 and/or an intra-chip conductor 346 as depicted in the example of FIG. 3.

As shown by the dashed line box in FIG. 5, the integrated radar device 510 (e.g., the microcontroller 518) also includes at least one switch 570 that is configured to be controlled to mitigate an impact on transmission line matching that might be caused by a conductor 540 that couples the I/O port 505 to the HSS interface 532. As shown in FIG. 5, microcontroller 518 includes a transmission switch 572 coupled between the I/O port 505 and the HSS interface 532.

The transmission switch 572 is arranged to interrupt the conductor 540 (e.g., to interrupt an intra-chip conductor 346 as shown in FIG. 3). As shown in FIG. 5, the transmission switch 572 includes a first end coupled to the input 551 and a second end coupled to the I/O port 505. The transmission switch 572 may be coupled as shown, embedded in the microcontroller 518 substrate proximal to the input 551 and distal from the I/O port 505. The transmission switch 572 is configured to controllable, for example via the processor(s) 534, to be opened to decouple the I/O port 505 from the HSS interface 532, or closed to couple the I/O port 505 to the HSS interface 532, depending on a mode of operation of the integrated radar device 510.

In the example of FIG. 5, microcontroller 518 also includes a termination switch 574 coupled between the I/O port 505 and the HSS interface 532. The termination switch 574 is coupled to a conductor 540 that couples the I/O port 505 to the HSS interface 532. In some examples, the termination switch 574 is embedded in the microcontroller 518 substrate and is coupled to the conductor 540 proximal to the HSS input 551 and distal from the I/O port 505 to mitigate a transmission line mismatch caused by the conductor 540 as much as possible.

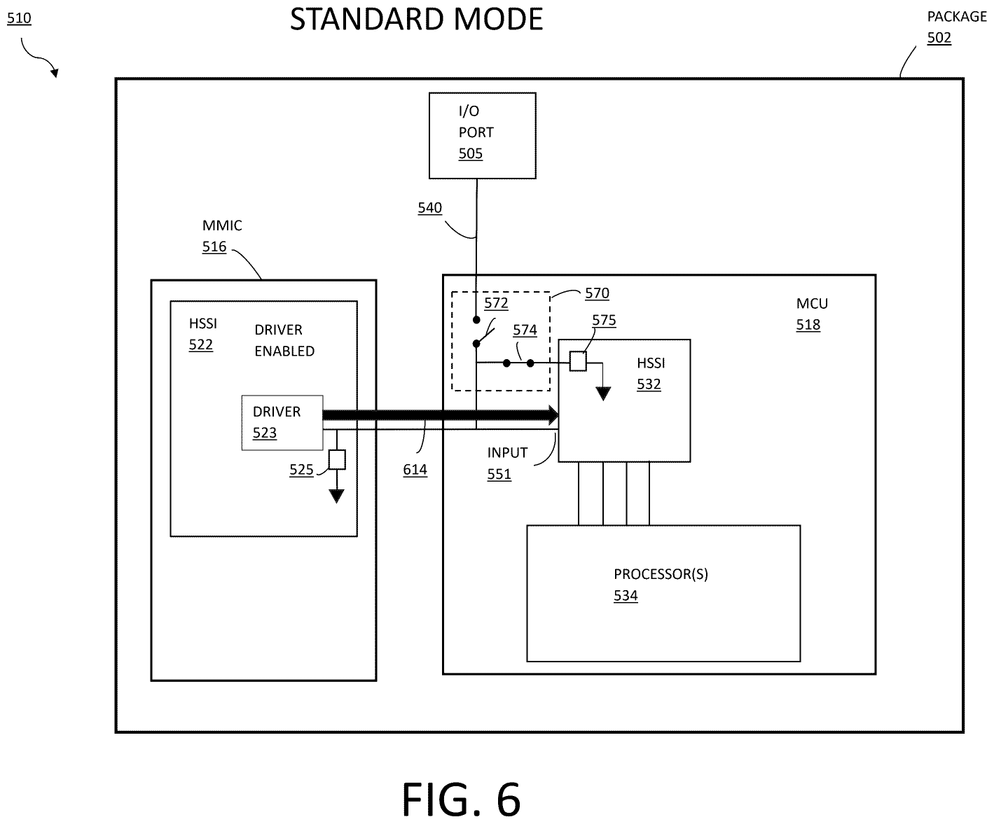

As shown in FIG. 5, the termination switch 574 includes a first end coupled to the conductor 540 (e.g., one of intra-chip conductors 345, 346 depicted in FIG. 3), which is coupled to the input 551 of the HSS interface 532, and a second end coupled to a termination resistor 575 of the HSS interface 532, which is in turn coupled to a ground reference. The termination switch 574 is configured to be controllable, for example via the processor(s) 534, to be opened to decouple the termination resistor 575 from the HSS interface 532, or closed to couple the termination resistor 575 to the HSS interface 532, depending on a mode of operation of the integrated radar device 510. FIGS. 6-8 depict integrated radar device 510 operated in standard, recording, and replay modes, respectively.

FIG. 6 shows integrated radar device 510 operated in a standard mode. In the standard mode, a driver 523 of the MMIC 516 HSS interface 522 is enabled, and as indicated by the black arrow in FIG. 6, operates to output raw radar data 614 to the HSS interface 532 of the microcontroller 518, which receives the raw radar data 614 at input 551. In the standard mode, no tool 409 is coupled to the I/O port 505. The HSS interface 532 outputs the raw radar data 614 to one or more processor(s) 534 of the microcontroller 518.

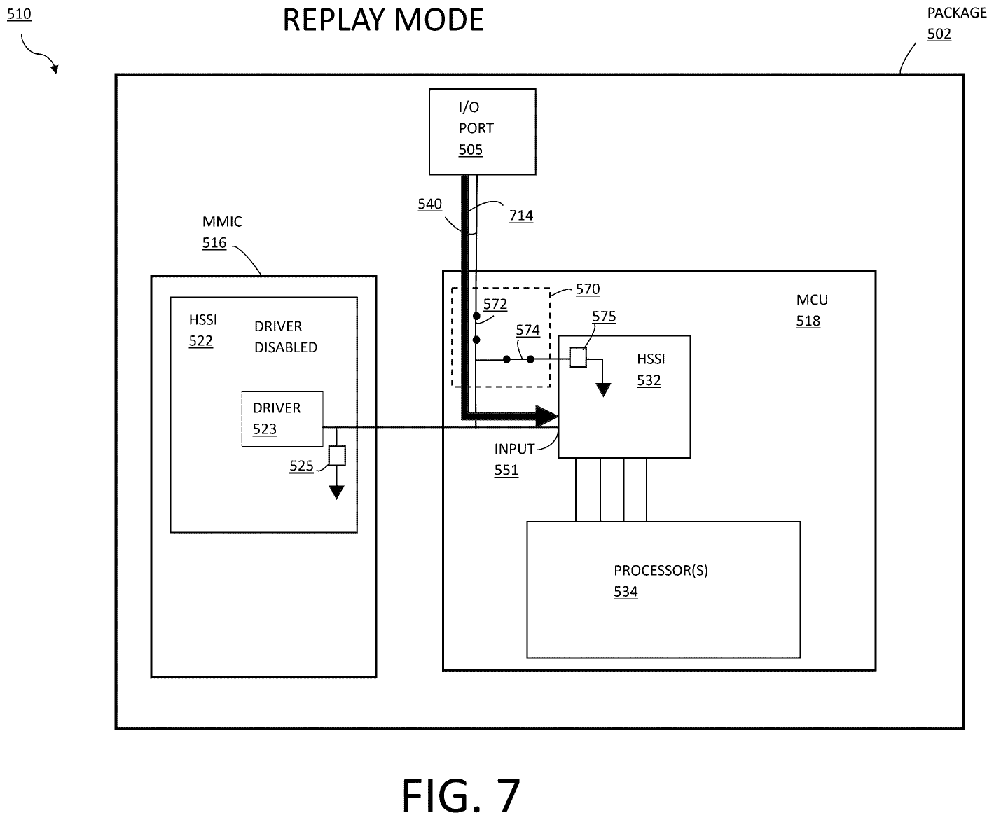

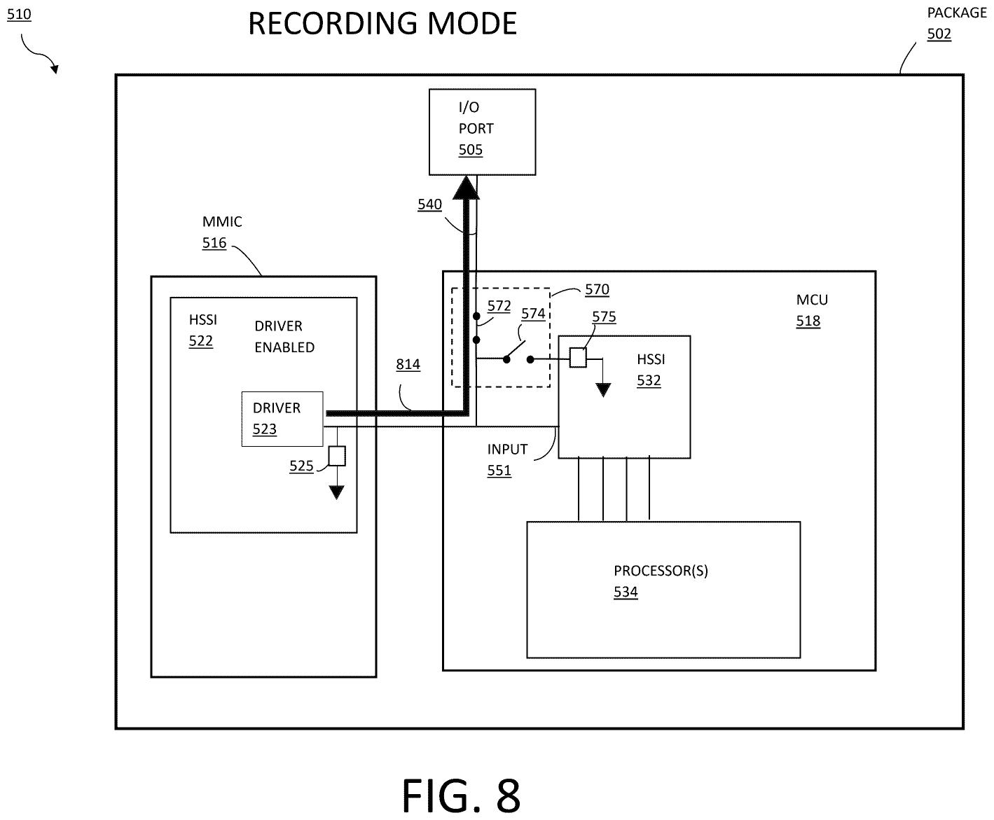

As shown in the example of FIG. 6, in the standard mode, the transmission switch 572 is opened, and the I/O port 505 is decoupled from the HSS interface 532. The transmission switch 572 may be arranged such that the I/O port 505 is decoupled from the input 551 close to the HSS interface 532. By decoupling the I/O port 505 (e.g., including the traces 340A, 340B depicted in the FIG. 3 example), a transmission line mismatch caused by conductor 540 that couples the I/O port 505 to the HSS interface 532 may be mitigated. In some examples, the transmission switch 572 is configured as a normally off switch that is configured to be opened as shown in FIG. 6 when a control voltage is not applied to a control gate of the transmission switch 572, and closed as shown in FIGS. 7 and 8 when a control voltage is applied to the control gate of the transmission switch 572.

As also shown in FIG. 6, in the standard mode, the termination switch 574 is closed, coupling the termination resistor 575 to the HSS interface 532. With the termination resistor 575 coupled to the HSS interface 532 as shown, HSS interface 532 may operate to communicate, matched with the HSS interface 522 of the MMIC 516, to receive raw radar data 614 from the MMIC 616 at high speeds. In some examples, the termination switch 574 is a normally on switch that is configured to be closed as shown in FIG. 6 when no control voltage is applied at a control gate of the termination switch 574, and opened when a control voltage is applied to the control gate of the termination switch 574, as shown in FIG. 8.

FIG. 7 shows integrated radar device 510 operated in a replay mode. In the replay mode, the driver 523 of the MMIC 516 HSS interface 522 is disabled and does not operate to output raw radar data to the microcontroller 518. As shown by the black arrow in FIG. 7, replay tool 454 may be coupled to the I/O port 505 to input previously recorded raw radar data 714 to the microcontroller 518.

As shown in the example of FIG. 7, the transmission switch 572 is closed, coupling the I/O port 505 to the HSS input 551, which couples the replay tool 454 to the HSS interface 532. As also shown in FIG. 7, the termination switch 574 is closed, coupling the termination resistor 575 to the HSS interface 532, such that HSS interface 532 is matched with the HSS interface 457 (including termination resistor 458) of the replay tool 454 to communicate previously recorded raw radar data 714 to the microcontroller 518 at high speeds.

FIG. 8 shows integrated radar device 510 operated in a recording mode. In the recording mode, the driver 523 of the MMIC 516 HSS interface 522 is enabled, and as indicated by the black arrow in FIG. 8, outputs raw radar data 814 to the HSS interface 532 of the microcontroller 518 within the package 502. According to the example of FIG. 8, a recording tool 450 may be coupled to the I/O port 505, to record raw radar data 814 as it is generated by the MMIC 516 and sent to microcontroller 518 within the package 502. As shown in the example of FIG. 8, the transmission switch 572 is closed in the recording mode, coupling the recording tool 450 to the HSS interface 532 via the I/O port 505.

As also shown in FIG. 8, in the recording mode, the termination switch 574 is opened to decouple the termination resistor 575 from the I/O port 505, so that the raw radar data 814 at input 551 of the HSS interface 532 can be recorded by the recording tool 450, without the termination resistor 575 of the HSS interface 532 causing a transmission line mismatch between the HSS interface 455 of the recording tool 450 (e.g., including termination resistor 456, as shown in FIG. 4) and the HSS interface 522 of the MMIC 516 (e.g., including termination resistor 525). In this manner, the recording tool 450 can receive raw radar data 814 from the MMIC 516 at high speeds, to record the same raw radar data 814 and sent to the microcontroller 518 within the package 502.

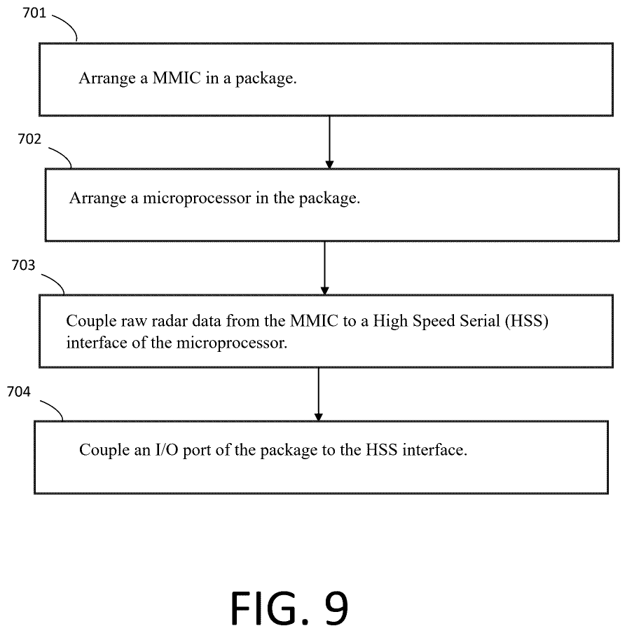

FIG. 9 is a flow diagram that depicts one example of a method of making an integrated radar device (e.g., 110, 210, 410, 510, 610, 710) according to some embodiments. As shown in FIG. 9, at step 701, the method includes arranging a MMIC (e.g., 216) in a package (e.g., 202). The MMIC is configured to output raw radar data (e.g., 214). Also shown in FIG. 9, at step 702, the method further includes arranging a microcontroller (e.g., 218) in the package. The MMIC is implemented in a first silicon substrate, and the microcontroller is implemented in a second silicon substrate different than the first silicon substrate.

As also shown in FIG. 9, at step 703, the method further includes coupling raw radar data from the MMIC to the microcontroller via a high-speed serial (HSS) interface (e.g., 232) that receives the raw radar data from the MMIC within the package and outputs the received raw radar data to one or more processor(s) (e.g., 234) of the microcontroller. For example, coupling raw radar data from the MMIC to the microcontroller may include coupling an HSS interface (e.g., 232) of the microcontroller to the MMIC (e.g., to corresponding HSS interface 222 of MMIC 216), for example by via a trace (e.g., 343A, 343B) on a printed circuit board (PCB) (e.g., 201, 301) coupled to an input (e.g., 444A, 444B) of the microcontroller.

As also shown in FIG. 9, the method further includes, at step 704, coupling an I/O port (e.g., 205) of the package to the HSS interface of the microcontroller. Coupling the I/O port to the HSS interface may include coupling the I/O port to the input (e.g., 251) of the HSS interface. In some examples, the method may further include using the I/O port (e.g., 205) to record raw radar data from the MMIC, and to input previously recorded raw radar data to the microcontroller. In some examples, using the I/O port to record the raw radar data from the MMIC includes recording the same raw radar data at the input of the HSS interface of the microcontroller. In some examples, using the I/O port to input previously recorded raw radar data to the microcontroller includes inputting the previously recorded raw radar data to the input of the HSS interface.

In some examples, coupling the I/O port (e.g., 205) of the package to the HSS interface comprises operating at least one switch coupled between the HSS interface and the I/O port. For example, coupling the I/O port of the package to the HSS interface may include using a transmission switch (e.g., 572) arranged between the HSS interface and the I/O port. In some examples, the method further includes closing the transmission switch in recording and replay modes, coupling the I/O port to the HSS interface. In some examples, the method further includes opening the transmission switch in a normal mode, decoupling the I/O port from the HSS interface.

As another example, coupling the I/O port of the package to the HSS interface may include using a termination switch (e.g., 574) arranged between the HSS interface (e.g., 232) and the I/O port (e.g., 205). For example, the termination switch may be coupled between a conductor (e.g., 540) that couples the I/O port to the HSS interface, and a termination resistor (e.g., 575). In some examples, the method further includes closing the termination switch in standard and replay modes, coupling the termination resistor to the HSS interface. In some examples, the method further includes opening the termination switch in the recording mode, decoupling the termination resistor from the HSS interface.

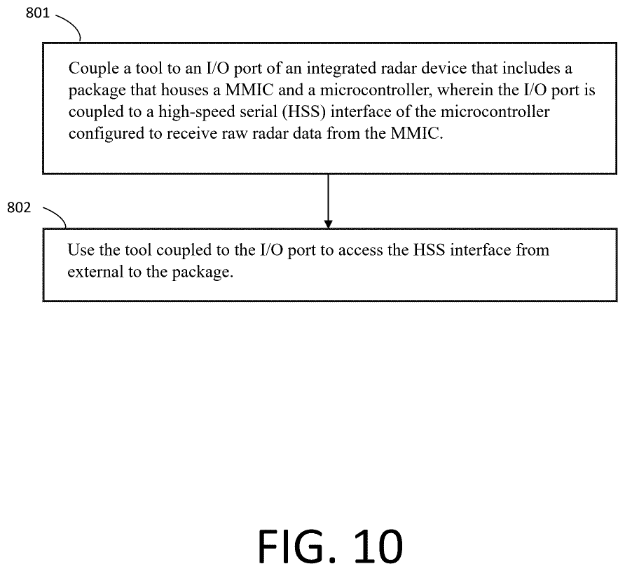

FIG. 10 is a flow diagram that depicts one example of a method of using an integrated radar device according to some embodiments. As shown in FIG. 10, the method includes, at step 801, coupling a tool (e.g., 409) to an I/O port (e.g., 205) of an integrated radar device (e.g., 210) that includes a package (e.g., 202) that houses a Monolithic Microwave Integrated Circuit (MMIC) (e.g., 216) and a microcontroller (e.g., 218) within the package. The MMIC is implemented in a first silicon substrate, and the microcontroller is implemented in a second silicon substrate different than and separate from the first silicon substrate. The I/O port is coupled to a high-speed serial (HSS) interface (e.g., 232) of the microcontroller configured to receive raw radar data from the MMIC within the package and output the received raw radar data to one or more processor(s) (e.g., 234) of the microcontroller. As also shown in FIG. 10, at step 802, the method further includes using the tool coupled to the I/O port to access the HSS interface (e.g., 232) from external to the package. In some examples, using the tool to access the HSS interface includes using the tool to record raw radar data from the MMIC from external to the package. In some examples, using the tool to access the HSS interface includes using the tool to input previously recorded raw radar data to the microcontroller from external to the package.

In some examples, the method further includes closing a transmission switch (e.g., 572) that is coupled between the I/O port and the HSS interface of the microcontroller, to couple the I/O port to the HSS interface, for example in recording or replay modes of the integrated radar device. In other examples, the method further includes opening a transmission switch (e.g., 572) that is coupled between the I/O port and the HSS interface of the microcontroller, to decouple the I/O port from the HSS interface, for example in a standard mode of the integrated radar device.

In some examples, the method further includes closing a termination switch (e.g., 574) that is coupled between the I/O port and the HSS interface of the microcontroller, to couple the HSS interface to a termination resistor (e.g., 575), for example in standard and replay modes of the integrated radar device. In other examples, the method further includes opening the termination switch to decouple the termination resistor from the HSS interface, for example in a recording mode of the integrated radar device.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

### Discussion of Possible Embodiments

The following are non-exclusive descriptions of possible embodiments of the present invention.

According to one aspect, a radar system includes a package, a Monolithic Microwave Integrated Circuit (MMIC) housed within the package and configured to output raw radar data, and a microcontroller housed within the package. The microcontroller includes a high-speed serial (HSS) interface configured to receive the raw radar data from the MMIC within the package and output the raw radar data to one or more processors of the microcontroller. The radar system further includes an I/O port coupled to the HSS interface.

The radar system of the preceding paragraph may optionally include, additionally and/or alternatively, any one or more of the following features, configurations and/or additional components alone or in combination with one another.

For example, in some aspects the radar system further includes at least one switch coupled between the HSS interface and the I/O port. As another example, in some aspects, the at least one switch comprises a transmission switch coupled between the HSS interface and the I/O port, wherein the transmission switch is configured to be: closed to couple the I/O port to the HSS interface, and opened to decouple the I/O port from the HSS interface. As another example, in some aspects, the switch comprises a termination switch coupled between a conductor that carries the raw radar data between the HSS interface and the I/O port and a termination resistor, wherein the termination switch is configured to be: closed to couple the termination resistor to the HSS interface, and opened to decouple the termination resistor from the HSS interface. As another example, in some aspects, the radar system is operable in standard mode, a recording mode, and a replay mode, and the transmission switch is configured to be: closed in the recording and replay modes, and opened in the standard mode. As another example, in some aspects, the radar system is operable in standard mode, a recording mode, and a replay mode, and the termination switch is configured to be closed in the standard and replay modes, and opened in the recording mode. As another example, in some aspects, the at least one switch is coupled between the HSS interface and the I/O port proximal to the HSS interface and distal from the I/O port. As another example, in some aspects, the HSS interface and the at least one switch are arranged at or near a corner of the microcontroller arranged adjacent to the MMIC. As another example, in some aspects, the I/O port is coupled to an input of the HSS interface. As another example, in some aspects, the I/O port is coupled to an input of the microcontroller that couples the input of the HSS interface to a trace on a printed circuit board (PCB) coupled to an output of the MMIC. As another example, in some aspects, the MMIC comprises a first semiconductor substrate arranged on a printed circuit board (PCB) in the package, and the microcontroller comprises a second semiconductor substrate different from the first semiconductor substrate arranged adjacent to the first semiconductor substrate on the PCB in the package. As another example, in some aspects, the I/O port is configured to be used to record raw radar data from the MMIC, and to input raw radar data to the microcontroller. As another example, in some aspects, the HSS interface is a mobile industry processor interface (MIPI) Camera Serial Interface 2 (CSI-2) or a MIPI Camera Serial Interface 3 (CSI-3).

According to another aspect, a method includes arranging a Monolithic Microwave Integrated Circuit (MMIC) in a package. The method further includes arranging a microcontroller in the package. The method further includes coupling raw radar data from the MMIC to the microcontroller via a high-speed serial (HSS) interface that receives the raw radar data from the MMIC within the package and outputs the received raw radar data to at least one processor of the microcontroller. The method further includes coupling an I/O port of the package to the HSS interface.

The method of the preceding paragraph may optionally include, additionally and/or alternatively, any one or more of the following features, configurations and/or additional steps alone or in combination with one another.

According to one example, in some aspects, coupling the I/O port of the package to the HSS interface comprises closing a transmission switch with a first end coupled to the HSS interface and a second end coupled to the I/O port. As another example, in some aspects, opening the transmission switch to decouple the I/O port from the HSS interface.

As another example, in some aspects, coupling a termination resistor to a conductor coupled between the HSS interface and the I/O port by closing a termination switch with a first end coupled to the conductor and a second end coupled to the termination resistor.

According to another aspect, a method includes coupling a tool to an I/O port of a radar system that includes a package that houses a Monolithic Microwave Integrated Circuit (MMIC) and a microcontroller within the package, wherein the I/O port is coupled to a high-speed serial (HSS) interface of the microcontroller configured to receive raw radar data from the MMIC within the package and output the received raw radar data to at least one processor of the microcontroller, and using the tool coupled to the I/O port to access the HSS interface from external to the package.

The method of the preceding paragraph may optionally include, additionally and/or alternatively, any one or more of the following features, configurations and/or additional steps alone or in combination with one another.

As an example, according to one aspect, the method includes using the tool coupled to the I/O port to access the HSS interface includes recording the raw radar data from the MMIC from external to the package. As another example, according to one aspect, using the tool coupled to the I/O port to access the HSS interface comprises inputting recorded raw radar data to the at least one processor from external to the package via the HSS interface.

According to another aspect, a radar system includes an antenna, a waveguide, and a package. The radar system further includes a Monolithic Microwave Integrated Circuit (MMIC) housed within the package and coupled to the antenna via the waveguide, wherein the MMIC is configured to output raw radar data. The radar system further includes a microcontroller housed within the package. The microcontroller includes a high-speed serial (HSS) interface that receives the raw radar data from the MMIC within the package and outputs the received raw radar data to at least one processor of the microcontroller. The radar system further includes an I/O port of the package coupled to the HSS interface.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

We claim:

1. A radar system, comprising:
a package;
a Monolithic Microwave Integrated Circuit (MMIC) housed within the package and configured to output raw radar data;
a microcontroller housed within the package, wherein the microcontroller includes a high-speed serial (HSS) interface configured to receive the raw radar data from the MMIC within the package and output the raw radar data to one or more processors of the microcontroller; and
an input/output (I/O) port of the package coupled to the HSS interface.

2. The radar system of claim 1, further comprising at least one switch coupled between the HSS interface and the I/O port.

3. The radar system of claim 1, wherein the at least one switch comprises a transmission switch coupled between the HSS interface and the I/O port, wherein the transmission switch is configured to be:
closed to couple the I/O port to the HSS interface; and
opened to decouple the I/O port from the HSS interface.

4. The radar system of claim 1, wherein the at least one switch comprises a termination switch coupled between a conductor that carries the raw radar data between the HSS interface and the I/O port and a termination resistor, wherein the termination switch is configured to be:
closed to couple the termination resistor to the HSS interface; and
opened to decouple the termination resistor from the HSS interface.

5. The radar system of claim 3, wherein the radar system is operable in standard mode, a recording mode, and a replay mode, and the transmission switch is configured to be:
closed in the recording and replay modes; and
opened in the standard mode.

6. The radar system of claim 4, wherein the radar system is operable in standard mode, a recording mode, and a replay mode, and the termination switch is configured to be:
closed in the standard and replay modes; and
opened in the recording mode.

7. The radar system of claim 2, wherein the at least one switch is coupled between the HSS interface and the I/O port proximal to the HSS interface and distal from the I/O port.

8. The radar system of claim 2, wherein the HSS interface and/or the at least one switch are arranged at or near a corner of the microcontroller arranged adjacent to the MMIC.

9. The radar system of claim 1, wherein the I/O port is coupled to an input of the HSS interface.

10. The radar system of claim 9, wherein the I/O port is coupled to an I/O port of the microcontroller that couples the input of the HSS interface to a trace on a printed circuit board (PCB) coupled to an output of the MMIC.

11. The radar system of claim 1, wherein the MMIC comprises a first semiconductor substrate arranged on a printed circuit board (PCB) in the package, and the microcontroller comprises a second semiconductor substrate different from the first semiconductor substrate arranged adjacent to the first semiconductor substrate on the PCB in the package.

12. The radar system of claim 1, wherein the I/O port is configured to be used to record raw radar data from the MMIC, and to input raw radar data to the microcontroller.

13. The radar system of claim 1, wherein the HSS interface is a mobile industry processor interface (MIPI) Camera Serial Interface 2 (CSI-2) or a MIPI Camera Serial Interface 3 (CSI-3).

14. A method, comprising:
arranging a Monolithic Microwave Integrated Circuit (MMIC) in a package;
arranging a microcontroller in the package;
coupling raw radar data from the MMIC to the microcontroller via a high-speed serial (HSS) interface that receives the raw radar data from the MMIC within the package and outputs the received raw radar data to at least one processor of the microcontroller; and
coupling an I/O port of the package to the HSS interface.

15. The method of claim 14, wherein coupling the I/O port of the package to the HSS interface comprises closing a transmission switch with a first end coupled to the HSS interface and a second end coupled to the I/O port.

16. The method of claim 15, further comprising:
opening the transmission switch to decouple the I/O port from the HSS interface.

17. The method of claim 14, further comprising:
coupling a termination resistor to a conductor coupled between the HSS interface and the I/O port by closing a termination switch with a first end coupled to the conductor and a second end coupled to the termination resistor.

18. A method, comprising:
coupling a tool to an I/O port of a radar system that includes a package that houses a Monolithic Microwave Integrated Circuit (MMIC) and a microcontroller within the package, wherein the I/O port is coupled to a high-speed serial (HSS) interface of the microcontroller configured to receive raw radar data from the MMIC within the package and output the received raw radar data to at least one processor of the microcontroller; and
using the tool coupled to the I/O port to access the HSS interface from external to the package.

19. The method of claim 18, wherein using the tool coupled to the I/O port to access the HSS interface includes recording the raw radar data from the MMIC from external to the package.

20. The method of claim 18, wherein using the tool coupled to the I/O port to access the HSS interface comprises inputting recorded raw radar data to the at least one processor from external to the package via the HSS interface.
